(19) United States
(12) Patent Application Publication
(10) Pub. No.: US 2004/0003555 A1
(43) Pub. Date: Jan. 8, 2004

(54) Glazing

(76) Inventor: Jean-Benoit Lhoest, Jumet (BE)

Correspondence Address: Piper Rudnick, Supervisor Patent Prosecution Services, 1200 Nineteenth Street NW, Washington, DC, 20036-2412, US

(21) Appl. No.: 10/333,126

(22) PCT Filed: Jul. 18, 2001
(86) PCT No.: PCT/EP01/08336

(30) Foreign Application Priority Data
Jul. 20, 2000 (EP) 00202585.6

(51) Int. Cl. E06B 1/04; E06B 3/00

(52) U.S. Cl. 52/213; 52/208; 52/204.53; 52/204.62

(57) ABSTRACT

A glazing panel (10) has a fixing element (31) adapted to participate in securing the glazing panel in a frame (35), which is secured to a surface of the of pvb or other glass laminating material (22). The arrangement may facilitate recycling.

This invention relates to glazing panels and particularly but not exclusively to an arrangement which may facilitate assembly of a vehicle glazing panel in a frame and/or recycling of the glazing panel at the end of its life.

Whilst the invention will be described with particular reference to laminated windscreens it may also be used in other applications, for example monolithic vehicle glazing panels, other laminated vehicle glazing, architectural glazing and other types of glazing.

A common way of assembling a windscreen in a car comprises using an extruded strip or bead of adhesive, for example a polyurethane adhesive, spaced from the periphery of the glazing to adhere one face of the windscreen in a frame which forms part of the vehicle's bodywork. The adhesive may contact a decorative enamel band printed onto a surface of the windscreen rather than being in direct contact with the glass; this band hides the fixation from view from the exterior of the vehicle and may also protect the adhesive from incident ultra violet radiation. A primer may be used to facilitate adhesion between the adhesive and the glazing or enamel band.

Such adhesive systems facilitate assembly of a glazing in a vehicle frame and provide useful mechanical properties. However, they are less than ideal when it comes to remove a glazing from the vehicle, for example to replace a damaged glazing or at the end of the vehicle's life. It may also be difficult to remove the adhesive from the surface of the glazing, for example to facilitate recycling of the glazing. Theses disadvantages are inherent as the adhesive is selected to have sufficient adhesion both to the vehicle frame and to the glazing to avoid undesired separation during the life of the vehicle. Often the adhesive is also chosen to have sufficient mechanical resistance to enable the glazing to contribute to the rigidity of the vehicle.

Separation of the glazing from the bodywork by cutting the adhesive, for example using a knife, is difficult and time consuming; the inaccessibility of the adhesive when the glazing is in place also makes this inconvenient. Even when accomplished it may still be necessary to remove the adhesive from the surface of the glazing if the glazing is to be recycled. Alternatively, a central portion of the glazing may be cut out and separated leaving a peripheral band of glazing still adhered to the bodywork via the adhesive. This is again time consuming and requires special tools and precautions. In addition, only a portion of the glazing is recuperated and can be recycled.

According to a first aspect, the present invention provides a vehicle glazing panel as defined in claim 1.

The use of a layer of glass laminating material to secure the fixing element at a surface of the glazing panel may enable the fixing element to be secured using a material which provides and adequate level of adhesion to the glazing panel and has suitable handling characteristics to facilitate mass production. This may be particularly advantageous in respect of a laminated glazing which has a laminating layer comprising a glass laminating material assembled with at least one glass sheet as the or part of the process used to laminate the glazing panel may also be used to secure the fixing element. Such processes may include degassing, for example in vacuum bags or by passing between the rollers of a calender, and subjecting to heat and pressure in an autoclave.

During a degassing operation, a preliminary adherence may be created between the fixing element and the glazing panel via the glass laminating material. Such preliminary adherence may be insufficient to secure the fixing element to the glazing panel; in this case, a securing step may be necessary.

The use of a glass laminating material to secure the fixing element may also facilitate recycling of the glazing panel; at the end of the life of the glazing panel, the fixing element may be separated from the glazing by intentionally destroying the glass laminating material's adhesion to the glazing surface. This may be particularly advantageous in the case of a laminated glazing comprising a glass laminating material laminating layer as de-lamination of the glass sheets comprising the glazing panel and detachment of the fixing element may be carried out using the same process or processes and/or may be carried out simultaneously.

The glass laminating material by means of which the fixing element is secured to the glazing panel may be or may comprise a material which may:

a) be treated so as to secure the fixing element to a surface of the glazing panel in a similar way to a polyvinyl butyral, for example in an autoclave; and/or

b) having served its function of securing the fixing element to a surface of the glazing panel may be treated so as to separate the fixing element from the glazing panel in a similar way to separating a polyvinyl butyral from glass, for example using water penetration to reduce adherence; and/or

c) be used to laminate together two sheets of glass.

Preferably, the glass laminating material by means of which the fixing element is secured to the glazing panel is or comprises polyvinyl butyral (pvb).

In the case of a laminated glazing, the glass laminating material by means of which the fixing element is secured to the glazing panel is preferably the same or substantially the same material as the glass laminating material of the laminating layer. The glass laminating material by means of which the fixing element is secured to the glazing panel need not have exactly the same properties as the laminating layer; for example, it need not be transparent.

The glass laminating material may have a thickness of between about 0.2 mm and about 1.2 mm.

One possible technique for separating two sheets of glass which are laminated together by a sheet of pvb comprises:

breaking the glass sheets, for example by passing the glazing through a roller or crusher to produce small fragments of glass which are still attached to the pvb layer, so as to provide a plurality of pathways via which water or water vapour may access the pvb sheet,

allowing water to penetrate the pvb sheet to a sufficient extent to weaken the adhesion between the pvb and the glass, for example by exposing the glazing to rain and the elements for a number of weeks or even months or submerging the glazing in a water bath, and

subsequently separating the glass from the layer of pvb.

The penetration of water may be enhance by using warm or hot water. The separation may be effected by mechanically scraping the pieces of glass from the pvb sheet once the adhesion has been weakened. The pvb and glass fragments may then be sorted manually and/or automatically.

Whilst existing techniques may not provide 100% separation of the pvb laminating layer from the glass, a sufficient degree of separation may be achieved to allow the glass to be re-introduced for example as cutlet into a glass furnace, for example for the manufacture of flat glass.

The present invention may allow the fixing element to be detached from the glazing panel using know techniques for separating a glass laminating material and glass.

The different components of the glazing panel may be separated and/or sorted so as to facilitate recycling and/or re-use. For example, if the fixing element comprises a magnetic metal then a magnet may be used in sorting this.

The fixing element may be secured by the glass laminating material directly to a surface of a glass sheet of the glazing panel. Alternatively, it may be secured to a layer or element secured to a surface of the glazing panel, for example a layer of an enamel material. Such an enamel material may be in the form of a masking band. The fixing element may remove the necessity of a masking band and/or may itself serve to mask the fixation of the glazing from the exterior and/or interior of the glazing panel.

The fixing element may comprise a metallic plate or bracket adapted to be secured to a portion of the vehicle's bodywork, for example, by bonding, by welding, by means of clips, screws or by bolts or other means. It may be particularly easy to sort and separate a metallic element as part of a recycling operation. Alternatively, the fixing element may be or may comprise a plastics material.

Where the glazing panel is a laminated glazing panel, use of a continuation of a laminating layer to provide the glass laminating material by means of which the fixing element is secured to the glazing panel may facilitate assembly of the fixing element at the glazing panel by avoiding the need for a separate piece of glass laminating material.

The laminating layer may be a sheet of polyvinyl butyral (pvb) having a thickness of between about 0.2 mm and 1.2 mm. Standard pvb thicknesses for car windscreens are 0.38 mm and 0.76 mm. The laminating layer may be a composite layer; it may comprises, for example, two sheets of pvb having another layer, for example a sheet of polyethylene terephtalate (pet) sandwiched between them. Such a pet (or other sheet) may carry a solar control coating, for example a magnetron sputtered coating stack adapted to enhance the solar control properties of the glazing. Each sheet of glass may have a thickness of between about 1 mm and 8 mm, particularly between about 1.5 mm and 3.5 mm, more particularly between about 1.8 mm and 2.5 mm. In the case of a laminated glazing, each sheet of glass need not have the same thickness.

Securing the fixing member at a portion of a laminated glazing panel at which two sheets of glass are offset may:

facilitate use of the laminating layer to additionally provide the glass laminating material by which the fixing element is secured to the glazing panel; and/or

facilitate use of an attachment portion which provides a flush surface with a surface of the glazing panel.

The invention may be particularly suitable for vehicle glazings, in particular automotive glazings in which the glazing panel is adapted to be assembled in a frame formed by the vehicle's bodywork.

According to a preferred embodiment, once secured in its frame, the glazing panel may be substantially flush with the frame. This means that the glazing panel 35 and the frame have a substantially continuous surface level, avoiding any significant discontinuity or step in the external assembly's surface. Flush fitting has the advantages of minimising any gap between the glazing and the frame, avoiding the build up of dirt at such interface, enhancing the aesthetic appearance, and giving better aerodynamic characteristics to vehicles, reducing undesirable noises.

According to another preferred embodiment, the fixing element is secured at a single surface of the glazing panel.

According to further aspects, the present invention provides a method of securing a fixing element to a glazing panel as defined in claim 9 and provides for use of a glazing panel as defined in claim 17.

Embodiments of the invention will now be described, by way of example only, with reference to the accompanying drawings of which:

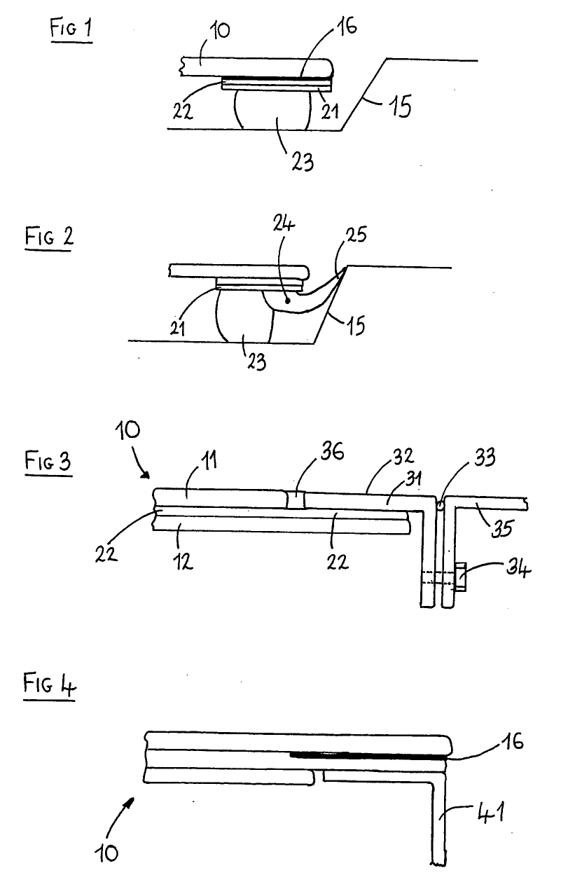

FIG. 1 is a sectional view through a peripheral portion of a monolithic glazing panel assembled in a frame;

FIG. 2 is a sectional view through a peripheral portion of an alternative glazing panel assembled in a frame;

FIG. 3 is a sectional view through a peripheral portion of a laminated windscreen;

FIG. 4 is a sectional view through a peripheral portion of an alternative laminated windscreen;

FIG. 5 is a plan view of a laminated windscreen;

FIG. 6 is a sectional view through a peripheral portion of a further form of a laminated windscreen assembled in a frame;

FIG. 7 is a sectional view through a peripheral portion of another form of a laminated windscreen assembled in a frame;

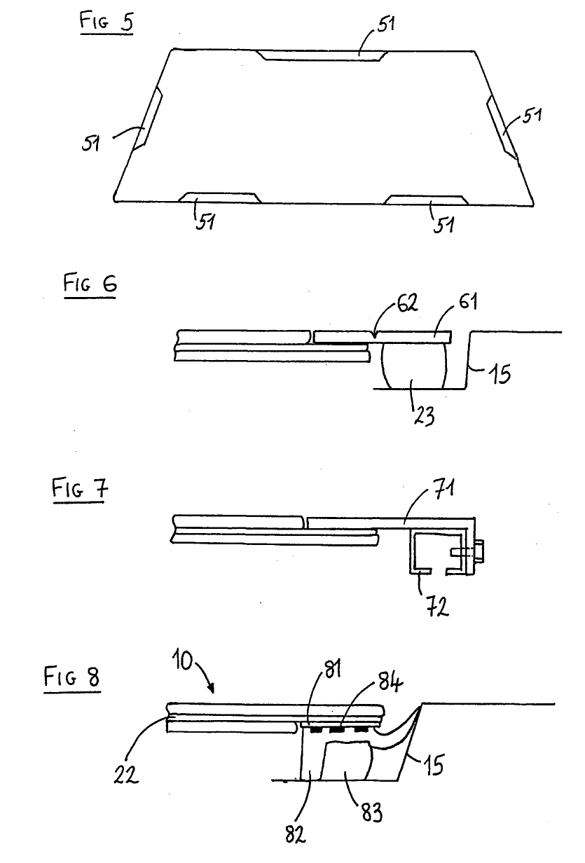

FIG. 8 is a sectional view through a peripheral portion of yet another form of a laminated windscreen assembled in a frame.

The vehicle glazing panel 10 of FIG. 1 is adapted to be secured into a frame 15 provided as part of a car's bodywork by means of a fixing member comprising a metal plate 21 secured by a layer of pvb 22 to a band of black enamel 16 carried on a surface of the glazing panel. The metallic plate 21 is bonded in the vehicle frame 15 by means of a bead of polyurethane adhesive 23. The metallic plate 21 and the adhesive bead 23 extend around the entire periphery of the glazing panel. In this way, the fixing element 21 participates in securing the glazing panel in the frame 15.

In the arrangement of FIG. 2, the metallic plate 21 also carries an elastomeric profile 24 having a lip 25 which contacts the vehicle frame 15.

It is clear that these first two embodiments could be used equally well with monolithic or laminated glazing panels.

The fixing element of FIG. 3 comprises a metallic bracket 31 secured to laminated windscreen 10 by means of a layer of pvb 22. The pvb layer 22 is a continuation of the pvb laminating layer by means of which the two glass sheets 11,12 which make up the glazing panel are laminated together. The fixing element 31 is secured at the external face of the glazing panel at a portion of the periphery of the glazing panel at which the two glass sheets are offset. In this way, an outer surface 32 of the fixing element is flush or substantially flush with the outer surface of the glazing panel. An optional spacer 36 is positioned between the fixing element 31 and the edge of the sheet of glass 11 which is set back from the peripheral edge of the glazing panel. The spacer 36 may provide a seal between the fixing element and this sheet of glass, for example to prevent or reduce ingress of dirt and/or water which may be detrimental to the laminating layer 22, and/or it may be decorative. The fixing element 31 is secured to the vehicle bodywork 35 by means of bolts 34 but could be fixed using clips or by bonding or welding. A seal 33 may be arranged between the fixing element and the vehicle bodywork. Particularly in this arrangement, but also in other possible embodiments, the fixing element 31 may have the same or a similar colour or surface appearance as the surrounding bodywork. This may provide an aesthetically pleasing appearance. In this embodiment, there is no need to provide a masking band on the glazing panel to hide the fixation of the glazing to the vehicle bodywork.

In the arrangement of FIG. 4, the fixing element 41 is secured at the inner face of glazing panel 10 at a portion where the two sheets of glass are offset. Fixing element 41 may be a metallic plate or bracket and is adapted to be secured to the vehicle's bodywork.

In the arrangement of FIG. 5, two sheets of glass which make up a laminated vehicle glazing are offset at spaced portions 51 around the periphery of the glazing panel. A fixing member (not shown) may be secured to the glazing panel at these portions. Alternatively, the two sheets which make up the laminated glazing panel may be offset around the entire periphery of the glazing panel.

FIG. 6 shows a fixing element 61 in the form of a metal plate secured at a surface of the glazing panel and glued into a frame 15 of a vehicle by means of a bead of adhesive 23. The metal plate 61 has a weakness in the form of an indentation 62 by means of which its integrity may be destroyed so as to permit the glazing to be removed from the frame leaving a portion of the metal plate and the bead of adhesive attached to the vehicle frame 15. The weakness 62 may be provided around the entire periphery of the glazing panel; alternatively, it may be provided at one or more discrete portions around the periphery so as to provide an access point to facilitate removal of the glazing. In the arrangement of FIG. 7, fixing element 71 is adapted to be secured directly to a part of the frame 72 of the vehicle.

FIG. 8 shows an arrangement in which a fixing element in the form of a metal plate 81 is secured to laminated glazing panel 22 by a continuation of the laminating layer of pvb 22 at the underside of the glazing panel at a position where the two sheets of glass of the glazing panel are offset. An extruded profile 82 secured to the fixing element is glued into frame 15 by a bead of adhesive 83. A heating element 84 is provided at the fixing element 81 to heat the fixing element 81 to encourage separation of the fixing element from the glazing panel when desired by melting, burning or otherwise reducing the adherence between the fixing element and the pvb 22. The heating element may be provided at and/or above and/or below the fixing element; it may comprise one or more wires and or conductive line, for example of an electrically conducive enamel, heatable by conduction of electricity and/or by induction.

Preferably, glazings according to the invention conform to European standard R43.

1. A glazing panel comprising a fixing element adapted to maintain the glazing panel secured in a frame, characterised in that the fixing element is secured at a surface of the glazing panel by means of a layer of glass laminating material.

2. A glazing panel in accordance with claim 1, in which the glazing panel is adapted to be fitted substantially flush within the frame.

3. A glazing panel in accordance with claim 1 or claim 2, in which the glazing panel is a laminated glazing comprising at least two sheets of glass laminated together by means of at least one laminating layer and in which the glass laminating material by means of which the fixing element is secured at a surface of the glazing panel comprises a continuation of the laminating layer.

4. A glazing panel in accordance with any preceding claim, in which the glazing panel is a laminated glazing comprising at least two sheets of glass laminated together by means of at least one laminating layer, in which the two sheets of glass are offset from each other at at least part of the periphery of the glazing panel and in which the fixing element is attached at a surface of the glazing panel at a portion of the glazing panel where the two sheets of glass are offset.

5. A glazing panel in accordance with any preceding claim, in which the fixing element comprises a frame which extends substantially around the entire periphery of the glazing panel.

6. A glazing panel in accordance with any preceding claim, in which the glass laminating material by means of which the fixing element is secured to a surface of the glazing panel comprises pvb.

7. A glazing panel in accordance with any preceding claim, in which the fixing element is secured at a single surface of the glazing panel.

8. A glazing panel in accordance with any preceding claim, in which the glazing panel is an automotive glazing panel.

9. A method of securing a fixing element to a glazing panel in which the fixing element is adapted to maintain the glazing panel secured in a frame, comprising the steps of:
a) assembling the fixing element at a surface of the glazing panel with a layer of a glass laminating material interposed between the fixing element and the glazing panel; and
b) treating the glass laminating material so as to cause adherence between the fixing element and the glazing panel.

10. A method in accordance with claim 9, in which the glazing panel is adapted to be fitted substantially flush within the frame.

11. A method in accordance with claim 9 or claim 10, in which the glass laminating material comprises pvb and in which the step of treating the pvb glass laminating material comprises simultaneously subjecting the pvb glass laminating material to a temperature of between about 120° C. and 145° C. and a to pressure of between about 0.8 and 1.6 MPa above atmospheric pressure.

12. A method in accordance with any one of claims 9 to 11, in which the glazing panel is a laminated glazing panel comprising at least two sheets of glass laminated together by means of at least one pvb laminating layer and in which the treatment of the pvb to cause adherence between the fixing element and the glazing panel is carried out simultaneously with a treatment to cause lamination between the two sheets of glass.

13. A method in accordance with any one of claims 9 to 12, in which the step of treating the glass laminating material so as to cause adherence between the fixing element and the glazing panel is carried out at least partially in an autoclave.

14. A method in accordance with any one of claims 9 to 13, comprising the additional step of subjecting the glazing panel having the fixing element assembled therewith to a degassing operation prior to the step of treating the glass laminating material so as to cause adherence between the fixing element and the glazing panel.

15. A method in accordance with any one of claims 9 to 14, in which the fixing element is secured at a single surface of the glazing panel.

16. A method in accordance with any one of claims 9 to 15, in which the glazing panel is an automotive glazing panel.

17. Use of a glazing panel in accordance with any one of claims 1 to 8 or of a method in accordance with any one of claims 9 to 15 to facilitate recycling of the glazing panel.
